(19) United States
(12) Patent Application Publication
(10) Pub. No.: US 2015/0029092 A1
(43) Pub. Date: Jan. 29, 2015

(54) SYSTEMS AND METHODS OF INTERPRETING COMPLEX GESTURES

(71) Applicant: Leap Motion, Inc., San Francisco, CA (US)

(72) Inventors: David HOLZ, San Francisco, CA (US); Matias PEREZ, San Francisco, CA (US); Neeloy ROY, San Francisco, CA (US); Maxwell Sills, San Francisco, CA (US)

(73) Assignee: LEAP MOTION, INC., San Francisco, CA (US)

(21) Appl. No.: 14/339,367

(22) Filed: Jul. 23, 2014

Related U.S. Application Data
(60) Provisional application No. 61/857,399, filed on Jul. 23, 2013.

(51) Int. Cl. G06F 3/01

(52) U.S. Cl. CPC G06F 3/017
USPC 345/156

(57) ABSTRACT

The technology disclosed relates to using a curvilinear gestural path of a control object as a gesture-based input command for a motion-sensing system. In particular, the curvilinear gestural path can be broken down into curve segments, and each curve segment can be mapped to a recorded gesture primitive. Further, certain sequences of gesture primitives can be used to identify the original curvilinear gesture.

### PRIORITY AND RELATED STATEMENT

This application claims the benefit of U.S. Provisional Patent Application No. 61/857,399, entitled, “DATA CLASSIFIERS FOR GESTURES,” filed on Jul. 23, 2013 (Attorney Docket No. LPM-022PR/7313311001). The provisional application is hereby incorporated by reference for all purposes.

### FIELD OF THE TECHNOLOGY DISCLOSED

The technology disclosed relates generally to motion capture and in particular to capturing motion information of objects during curvilinear free-form gestures.

### INCORPORATIONS

Materials incorporated by reference in this filing include the following:

“NON-LINEAR MOTION CAPTURE USING FRENET-SERRET FRAMES”, U.S. Non. Prov. application Ser. No. 14/338,136, filed 22 Jul. 2014 (Attorney Docket No. LEAP 1058-2/LPM-027US),

“DETERMINING POSITIONAL INFORMATION FOR AN OBJECT IN SPACE”, U.S. Non. Prov. application Ser. No. 14/214,605, filed 14 Mar. 2014 (Attorney Docket No. LEAP 1000-4/LMP-016US),

“RESOURCE-RESPONSIVE MOTION CAPTURE”, U.S. Non. Prov. application Ser. No. 14/214,569, filed 14 Mar. 2014 (Attorney Docket No. LEAP 1041-2/LPM-017US),

“PREDICTIVE INFORMATION FOR FREE SPACE GESTURE CONTROL AND COMMUNICATION”, U.S. Prov. App. No. 61/873,758, filed 4 Sep. 2013 (Attorney Docket No. LEAP 1007-1/LMP-1007APR),

“VELOCITY FIELD INTERACTION FOR FREE SPACE GESTURE INTERFACE AND CONTROL”, U.S. Prov. App. No. 61/891,880, filed 16 Oct. 2013 (Attorney Docket No. LEAP 1008-1/1009APR),

“INTERACTIVE TRAINING RECOGNITION OF FREE SPACE GESTURES FOR INTERFACE AND CONTROL”, U.S. Prov. App. No. 61/872,538, filed 30 Aug. 2013 (Attorney Docket No. LPM-013GPR),

“DRIFT CANCELLATION FOR PORTABLE OBJECT DETECTION AND TRACKING”, U.S. Prov. App. No. 61/938,635, filed 11 Feb. 2014 (Attorney Docket No. LEAP 1037-1/LPM-1037PR),

“IMPROVED SAFETY FOR WEARABLE VIRTUAL REALITY DEVICES VIA OBJECT DETECTION AND TRACKING”, U.S. Prov. App. No. 61/981,162, filed 17 Apr. 2014 (Attorney Docket No. LEAP 1050-1/LPM-1050PR),

“WEARABLE AUGMENTED REALITY DEVICES WITH OBJECT DETECTION AND TRACKING”, U.S. Prov. App. No. 62/001,044, filed 20 May 2014 (Attorney Docket No. LEAP 1061-1/LPM-1061PR),

“METHODS AND SYSTEMS FOR IDENTIFYING POSITION AND SHAPE OF OBJECTS IN THREE-DIMENSIONAL SPACE”, U.S. Prov. App. No. 61/587,554, filed 17 Jan. 2012, (Attorney Docket No. PA5663PRV),

“SYSTEMS AND METHODS FOR CAPTURING MOTION IN THREE-DIMENSIONAL SPACE”, U.S. Prov. App. No. 61/724,091, filed 8 Nov. 2012, (Attorney Docket No. LPM-001PR2/7312201010),

“NON-TACTILE INTERFACE SYSTEMS AND METHODS”, U.S. Prov. App. No. 61/816,487, filed 26 Apr. 2013 (Attorney Docket No. LPM-028PR/7313971001),

“DYNAMIC USER INTERACTIONS FOR DISPLAY CONTROL”, U.S. Prov. App. No. 61/752,725, filed 15 Jan. 2013, (Attorney Docket No. LPM-013APR/7312701001),

“VEHICLE MOTION SENSORY CONTROL”, U.S. Prov. App. No. 62/005,981, filed 30 May 2014, (Attorney Docket No. LEAP 1052-1/LPM-1052PR),

“MOTION CAPTURE USING CROSS-SECTIONS OF AN OBJECT”, U.S. application Ser. No. 13/414,485, filed 7 Mar. 2012, (Attorney Docket No. LPM-001/7312202001), and

“SYSTEM AND METHODS FOR CAPTURING MOTION IN THREE-DIMENSIONAL SPACE”, U.S. application Ser. No. 13/742,953, filed 16 Jan. 2013, (Attorney Docket No. LPM-001CP2/7312204002).

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Traditionally, users have interacted with electronic devices (such as a computer or a television) or computing applications (such as computer games, multimedia applications, or office applications) via indirect input devices, including, for example, keyboards, joysticks, or remote controllers. The user manipulates the input devices to perform a particular operation, such as selecting a specific entry from a menu of operations. Modern input devices, however, include multiple buttons, often in a complex configuration, to facilitate communication of user commands to the electronic devices or computing applications; correct operation of these input devices is often challenging to the user. Additionally, actions performed on an input device generally do not correspond in any intuitive sense to the resulting changes on, for example, a screen display controlled by the device. Input devices can also be lost, and the frequent experience of searching for misplaced devices has become a frustrating staple of modern life.

Touch screens implemented directly on user-controlled devices have obviated the need for separate input devices. A touch screen detects the presence and location of a “touch” performed by a user's finger or other object on the display screen, enabling the user to enter a desired input by simply touching the proper area of a screen. While suitable for small display devices such as tablets and wireless phones, touch screens are impractical for large entertainment devices that the user views from a distance. Particularly for games implemented on such devices, electronics manufacturers have developed systems that detect a user's movements or gestures and cause the display to respond in a contextually relevant manner. The user's gestures can be detected using an optical imaging system, and characterized and interpreted by suitable computational resources. For example, a user near a TV can perform a sliding hand gesture, which is detected by the gesture-recognition system; in response to the detected gesture, the TV can activate and display a control panel on the screen, allowing the user to make selections thereon using subsequent gestures; for example, the user can move her hand in an “up” or “down” direction, which, again, is detected and interpreted to facilitate channel selection.

Existing systems, however, rely on additional input elements (e.g., computer mice and keyboards) to supplement any gesture-recognition they can perform. These systems lack the user-interface elements required for anything more than simple commands, and often, recognize these commands only after the user has set up a gesture-recognition environment via a keyboard and mouse. Consequently, there is a need for a gesture-recognition system that allows users to interact with a wider variety of applications and games in a more sophisticated manner.

### SUMMARY

The technology disclosed relates to using a curvilinear gestural path of a control object as a gesture-based input command for a motion-sensing system. In particular, the curvilinear gestural path can be broken down into curve segments, and each curve segment can be mapped to a recorded gesture primitive. Further, certain sequences of gesture primitives can be used to identify the original curvilinear gesture.

Implementations of the technology disclosed relate to methods and systems for mapping gesture primitives to the gestural path of an object as it moves in 3D space. The gesture primitives can be curves (e.g., parabolas), and can be mapped to segments of the object path on the basis of geometric conformity and, in some implementations, rules governing allowable sequences or combinations of primitives. Different gesture primitives can be assigned different, unique tags (e.g., characters); gestures can be identified by recognizing certain sequences of gesture tags. The gesture tags in a sequence can be related to each other based on physical properties of gestures and/or the objects making them; certain gesture tags can always or never follow certain other gesture tags, for example. Based on these dependences, gestures can be identified sooner and future motion of the object can be predicted.

In one implementation, a system for classifying gestures includes database comprising a first plurality of electronically stored records relating path segments to gesture primitives, and a second database comprising a second plurality of electronically stored records relating sequences of gesture primitives to user input. A processor is configured for querying the first database to map segments of the path to one or more curve-based gesture primitives, computationally identifying a sequence of the gesture primitives mapped to segments of the path, and querying the second database to identify user input associated with the sequence.

The processor can be further configured for predicting a future motion of the object based on the sequence of gesture primitives and/or for selecting one of a plurality of gesture primitives mapped to a segment of the path based on gesture primitives assigned to other segments of the path. At least some of the gesture primitives can be parabolas. A user-interface element responsive to the user input can be displayed. The computer processor can be further configured for generating a new gesture primitive based on a segment of the path. Mapping segments of the path can include computing a curvature or torsion of the path or a velocity of the object. Parameters of the gesture-based primitives can include curvature, torsion, or velocity.

In another aspect, a method for classifying gestures includes capturing a plurality of digital images of an object in 3D space, storing, in a computer memory, a digital representation of a path of movement of the object based on the captured images, computationally mapping segments of the path to one or more curve-based gesture primitives stored in a database, computationally identifying a sequence of the gesture primitives mapped to segments of the path, and computationally identifying user input associated with the pattern.

A future motion of the object can be predicted based on the sequence of gesture primitives. One of a plurality of gesture primitives mapped to a segment of the path can be selected based on gesture primitives assigned to other segments of the path. At least some of the gesture primitives can be parabolas. A user-interface element responsive to the user input can be displayed. A new gesture primitive can be defined based on a segment of the path. A curvature or torsion of the path or a velocity of the object can be computed. Parameters of the gesture-based primitives can include curvature, torsion, or velocity.

Reference throughout this specification to “one example,” “an example,” “one implementation,” or “an implementation” means that a particular feature, structure, or characteristic described in connection with the example is included in at least one example of the present technology. Thus, the occurrences of the phrases “in one example,” “in an example,” “one implementation,” or “an implementation” in various places throughout this specification are not necessarily all referring to the same example. Furthermore, the particular features, structures, routines, steps, or characteristics can be combined in any suitable manner in one or more examples of the technology. The headings provided herein are for convenience only and are not intended to limit or interpret the scope or meaning of the claimed technology.

Advantageously, some implementations can provide for improved interface with computing and/or other machinery than would be possible with heretofore known techniques. In some implementations, a richer human-machine interface experience can be provided. The following detailed description together with the accompanying drawings will provide a better understanding of the nature and advantages provided for by implementations.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 illustrates an exemplary motion-capture system in accordance with implementations of the technology disclosed.

FIG. 2 illustrates an exemplary computer system for image processing, analysis, and display in accordance with implementations of the technology disclosed.

FIG. 3 shows one implementation of exemplary second and third order curves.

FIG. 4 illustrates one implementation of a template library of gesture primitives used to decompose detected gestures of a control object.

FIG. 5 depicts one implementation of complex gesture interpretation.

FIG. 6 is a flowchart showing a method of interpreting complex gestures.

FIG. 7 is one implementation of detecting erroneous interpretation of a gesture.

FIG. 8 is a representative method of detecting erroneous interpretation of a gesture.

FIG. 9 illustrates a method of detecting erroneous interpretation of a gesture by generating frequency distributions of curve segment and gesture primitive sequences.

### DESCRIPTION

### Introduction

A common problem with real-time motion-based control is the accurate capture of a user's gesture (or of the user's intended gesture). For example, an inherent unsteadiness of a user's hand and/or errors in the hardware or software used to capture the motion (or any other such disturbances) can cause the resulting output of the system to be unsettled or jerky.

Existing filtering systems and/or signal-conditioning techniques attempt to eliminate these errors, but one factor limiting their effectiveness is the fact that existing motion-capture systems operate in (x,y,z) Cartesian coordinates. At least because these coordinates are not independent of each other with respect to typical human motion (i.e., such motion is rarely along perfectly straight lines), Cartesian coordinates are suboptimal for filtering of motion to smooth out noise in 3D space, particularly for complex functions that define nonlinear paths. A motion-capture system that filters motion in 3D space in a manner better tailored to gestural movements is therefore needed.

The technology disclosed solves the technical problem of accurately capturing complex curvilinear gestures of a control object in 3D sensory space. The solution includes capturing a plurality of digital images of a non-linear free-form gesture in a three-dimensional (3D) sensory space performed by a control object and determining a path of movement of the control object during the non-linear free-form gesture. It also includes segmenting the path into multiple curve segments at least one of vertices, mid-points, and inflection points and piecewise fitting at least some of the curve segments to second or third order curves. It further includes identifying curve primitives in a library that match the piecewise curved segments, mapping one or more geometric attributes of the piecewise curve segments to parameters of the curve primitives, and forwarding the mapped parameters and curve primitives to a further process for interpretation as commands.

The technology disclosed also solves the technical problem of detecting erroneous interpretation of a gesture. The solution includes automatically correcting erroneous gesture detections by representing a sequence of gesture primitives mapped to gesture segments of a gesture as a gesture-tag sequence. It further includes anticipating a next component of gesture-tags in the gesture-tag sequence based on a model sequence of gesture primitives that identifies future occurrences of one or more subsequent gesture-tags given prior occurrences of one or more previous gesture-tags. It also includes comparing the anticipated component with an actual component of gesture-tags representing next gesture primitives and determining an erroneous fitting of the gesture segments responsive to detecting a mismatch between the next component and actual component.

As used herein, a given signal, event or value is “responsive to” a predecessor signal, event or value of the predecessor signal, event or value influenced by the given signal, event or value. If there is an intervening processing element, step or time period, the given signal, event or value can still be “responsive to” the predecessor signal, event or value. If the intervening processing element or step combines more than one signal, event or value, the signal output of the processing element or step is considered “responsive to” each of the signal, event or value inputs. If the given signal, event or value is the same as the predecessor signal, event or value, this is merely a degenerate case in which the given signal, event or value is still considered to be “responsive to” the predecessor signal, event or value. “Responsiveness” or “dependency” or “basis” of a given signal, event or value upon another signal, event or value is defined similarly.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

### Motion-Capture System

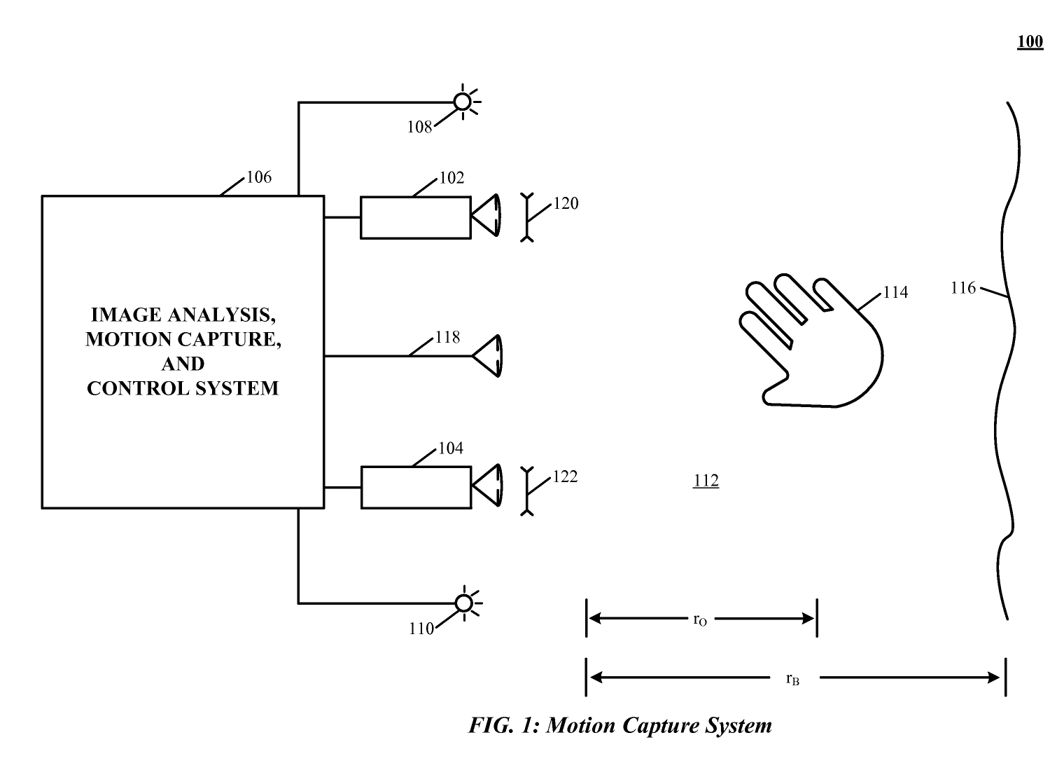

Motion-capture systems generally include (i) a camera for acquiring images of an object; (ii) a computer for processing the images to identify and characterize the object; and (iii) a computer display for displaying information related to the identified/characterized object. Referring first to FIG. 1, which illustrates an exemplary motion-capture system 100 including any number of cameras 102, 104 coupled to an image analysis, motion capture, and control system 106 (The system 106 is hereinafter variably referred to as the “image analysis and motion capture system,” the “image analysis system,” the “motion capture system,” “the gesture recognition system,” the “control and image-processing system,” the “control system,” or the “image-processing system,” depending on which functionality of the system is being discussed.).

Cameras 102, 104 provide digital image data to the image analysis, motion capture, and control system 106, which analyzes the image data to determine the three-dimensional (3D) position, orientation, and/or motion of the object 114 the field of view of the cameras 102, 104. Cameras 102, 104 can be any type of cameras, including cameras sensitive across the visible spectrum or, more typically, with enhanced sensitivity to a confined wavelength band (e.g., the infrared (IR) or ultraviolet bands); more generally, the term “camera” herein refers to any device (or combination of devices) capable of capturing an image of an object and representing that image in the form of digital data. While illustrated using an example of a two camera implementation, other implementations are readily achievable using different numbers of cameras or non-camera light sensitive image sensors or combinations thereof. For example, line sensors or line cameras rather than conventional devices that capture a two-dimensional (2D) image can be employed. Further, the term “light” is used generally to connote any electromagnetic radiation, which may or may not be within the visible spectrum, and can be broadband (e.g., white light) or narrowband (e.g., a single wavelength or narrow band of wavelengths).

Cameras 102, 104 are preferably capable of capturing video images (i.e., successive image frames at a constant rate of at least 15 frames per second); although no particular frame rate is required. The capabilities of cameras 102, 104 are not critical to the technology disclosed, and the cameras can vary as to frame rate, image resolution (e.g., pixels per image), color or intensity resolution (e.g., number of bits of intensity data per pixel), focal length of lenses, depth of field, etc. In general, for a particular application, any cameras capable of focusing on objects within a spatial volume of interest can be used. For instance, to capture motion of the hand of an otherwise stationary person, the volume of interest can be defined as a cube approximately one meter on a side. To capture motion of a running person, the volume of interest might have dimensions of tens of meters in order to observe several strides.

Cameras 102, 104 can be oriented in any convenient manner. In one implementation, the optical axes of the cameras 102, 104 are parallel, but this is not required. As described below, each of the 102, 104 can be used to define a “vantage point” from which the object 114 is seen; if the location and view direction associated with each vantage point are known, the locus of points in space that project onto a particular position in the cameras' image plane can be determined. In some implementations, motion capture is reliable only for objects in an area where the fields of view of cameras 102, 104; the cameras 102, 104 can be arranged to provide overlapping fields of view throughout the area where motion of interest is expected to occur.

In some implementations, the illustrated system 100 includes one or more sources 108, 110, which can be disposed to either side of cameras 102, 104, and are controlled by image analysis and motion capture system 106. In one implementation, the sources 108, 110 are light sources. For example, the light sources can be infrared light sources, e.g., infrared light emitting diodes (LEDs), and cameras 102, 104 can be sensitive to infrared light. Use of infrared light can allow the motion-capture system 100 to operate under a broad range of lighting conditions and can avoid various inconveniences or distractions that can be associated with directing visible light into the region where the person is moving. However, a particular wavelength or region of the electromagnetic spectrum can be required. In one implementation, filters 120, 122 are placed in front of cameras 102, 104 to filter out visible light so that only infrared light is registered in the images captured by cameras 102, 104. In another implementation, the sources 108, 110 are sonic sources providing sonic energy appropriate to one or more sonic sensors (not shown in FIG. 1 for clarity sake) used in conjunction with, or instead of, cameras 102, 104. The sonic sources transmit sound waves to the user; with the user either blocking (“sonic shadowing”) or altering the sound waves (“sonic deflections”) that impinge upon her. Such sonic shadows and/or deflections can also be used to detect the user's gestures and/or provide presence information and/or distance information using ranging techniques. In some implementations, the sound waves are, for example, ultrasound, which are not audible to humans.

It should be stressed that the arrangement shown in FIG. 1 is representative and not limiting. For example, lasers or other light sources can be used instead of LEDs. In implementations that include laser(s), additional optics (e.g., a lens or diffuser) can be employed to widen the laser beam (and make its field of view similar to that of the cameras). Useful arrangements can also include short-angle and wide-angle illuminators for different ranges. Light sources are typically diffuse rather than specular point sources; for example, packaged LEDs with light-spreading encapsulation are suitable.

In operation, light sources 108, 110 are arranged to illuminate a region of interest 112 that includes an entire control object or its portion 114 (in this example, a hand) that can optionally hold a tool or other object of interest. Cameras 102, 104 are oriented toward the region 112 to capture video images of the hand 114. In some implementations, the operation of light sources 108, 110 and cameras 102, 104 is controlled by the image analysis and motion capture system 106, which can be, e.g., a computer system, control logic implemented in hardware and/or software or combinations thereof. Based on the captured images, image analysis and motion capture system 106 determines the position and/or motion of hand 114.

Motion capture can be improved by enhancing contrast between the object of interest 114 and background surfaces like surface 116 visible in an image, for example, by means of controlled lighting directed at the object. For instance, in motion capture system 106 where an object of interest 114, such as a person's hand, is significantly closer to the cameras 102 and 104 than the background surface 116, the falloff of light intensity with distance (1/r² for point like light sources) can be exploited by positioning a light source (or multiple light sources) near the camera(s) or other image-capture device(s) and shining that light onto the object 114. Source light reflected by the nearby object of interest 114 can be expected to be much brighter than light reflected from more distant background surface 116, and the more distant the background (relative to the object), the more pronounced the effect will be. Accordingly, a threshold cut off on pixel brightness in the captured images can be used to distinguish “object” pixels from “background” pixels. While broadband ambient light sources can be employed, various implementations use light having a confined wavelength range and a camera matched to detect such light; for example, an infrared source light can be used with one or more cameras sensitive to infrared frequencies.

In operation, cameras 102, 104 are oriented toward a region of interest 112 in which an object of interest 114 (in this example, a hand) and one or more background objects 116 can be present. Light sources 108, 110 are arranged to illuminate region 112. In some implementations, one or more of the light sources 108, 110 and one or more of the cameras 102, 104 are disposed below the motion to be detected, e.g., in the case of hand motion, on a table or other surface beneath the spatial region where hand motion occurs. This is an optimal location because the amount of information recorded about the hand is proportional to the number of pixels it occupies in the camera images, and the hand will occupy more pixels when the camera's angle with respect to the hand's “pointing direction” is as close to perpendicular as possible. Further, if the cameras 102, 104 are looking up, there is little likelihood of confusion with background objects (clutter on the user's desk, for example) and other people within the cameras' field of view.

Control and image-processing system 106, which can be, e.g., a computer system, can control the operation of light sources 108, 110 and cameras 102, 104 to capture images of region 112. Based on the captured images, the image-processing system 106 determines the position and/or motion of object 114. For example, as a step in determining the position of object 114, image-analysis system 106 can determine which pixels of various images captured by cameras 102, 104 contain portions of object 114. In some implementations, any pixel in an image can be classified as an “object” pixel or a “background” pixel depending on whether that pixel contains a portion of object 114 or not. With the use of light sources 108, 110, classification of pixels as object or background pixels can be based on the brightness of the pixel. For example, the distance (r_{O}) between an object of interest 114 and cameras 102, 104 is expected to be smaller than the distance (r_{B}) between background object(s) 116 and cameras 102, 104. Because the intensity of light from sources 108, 110 decreases as 1/r², object 114 will be more brightly lit than background 116, and pixels containing portions of object 114 (i.e., object pixels) will be correspondingly brighter than pixels containing portions of background 116 (i.e., background pixels). For example, if r_{B}/r_{O}=2, then object pixels will be approximately four times brighter than background pixels, assuming object 114 and background 116 are similarly reflective of the light from sources 108, 110, and further assuming that the overall illumination of region 112 (at least within the frequency band captured by cameras 102, 104) is dominated by light sources 108, 110. These conditions generally hold for suitable choices of cameras 102, 104, light sources 108, 110, filters 120, 122, and objects commonly encountered. For example, light sources 108, 110 can be infrared LEDs capable of strongly emitting radiation in a narrow frequency band, and filters 120, 122 can be matched to the frequency band of light sources 108, 110. Thus, although a human hand or body, or a heat source or other object in the background, can emit some infrared radiation, the response of cameras 102, 104 can still be dominated by light originating from sources 108, 110 and reflected by object 114 and/or background 116.

In this arrangement, image-analysis system 106 can quickly and accurately distinguish object pixels from background pixels by applying a brightness threshold to each pixel. For example, pixel brightness in a CMOS sensor or similar device can be measured on a scale from 0.0 (dark) to 1.0 (fully saturated), with some number of gradations in between depending on the sensor design. The brightness encoded by the camera pixels scales standardly (linearly) with the luminance of the object, typically due to the deposited charge or diode voltages. In some implementations, light sources 108, 110 are bright enough that reflected light from an object at distance r_{O} produces a brightness level of 1.0 while an object at distance r_{B}=2r_{O} produces a brightness level of 0.25. Object pixels can thus be readily distinguished from background pixels based on brightness. Further, edges of the object can also be readily detected based on differences in brightness between adjacent pixels, allowing the position of the object within each image to be determined. Correlating object positions between images from cameras 102, 104 allows image-analysis system 106 to determine the location in 3D space of object 114, and analyzing sequences of images allows image-analysis system 106 to reconstruct 3D motion of object 114 using motion algorithms.

In accordance with various implementations of the technology disclosed, the cameras 102, 104 (and typically also the associated image-analysis functionality of control and image-processing system 106) are operated in a low-power mode until an object of interest 114 is detected in the region of interest 112. For purposes of detecting the entrance of an object of interest 114 into this region, the system 100 further includes one or more light sensors 118 (e.g., a CCD or CMOS sensor) and/or an associated imaging optic (e.g., a lens) that monitor the brightness in the region of interest 112 and detect any change in brightness. For example, a single light sensor including, e.g., a photodiode that provides an output voltage indicative of (and over a large range proportional to) a measured light intensity can be disposed between the two cameras 102, 104 and oriented toward the region of interest 112. The one or more sensors 118 continuously measure one or more environmental illumination parameters such as the brightness of light received from the environment. Under static conditions—which implies the absence of any motion in the region of interest 112—the brightness will be constant. If an object enters the region of interest 112, however, the brightness can abruptly change. For example, a person walking in front of the sensor(s) 118 can block light coming from an opposing end of the room, resulting in a sudden decrease in brightness. In other situations, the person can reflect light from a light source in the room onto the sensor, resulting in a sudden increase in measured brightness.

The aperture of the sensor(s) 118 can be sized such that its (or their collective) field of view overlaps with that of the cameras 102, 104. In some implementations, the field of view of the sensor(s) 118 is substantially co-existent with that of the cameras 102, 104 such that substantially all objects entering the camera field of view are detected. In other implementations, the sensor field of view encompasses and exceeds that of the cameras. This enables the sensor(s) 118 to provide an early warning if an object of interest approaches the camera field of view. In yet other implementations, the sensor(s) capture(s) light from only a portion of the camera field of view, such as a smaller area of interest located in the center of the camera field of view.

The control and image-processing system 106 monitors the output of the sensor(s) 118, and if the measured brightness changes by a set amount (e.g., by 10% or a certain number of candela), it recognizes the presence of an object of interest in the region of interest 112. The threshold change can be set based on the geometric configuration of the region of interest and the motion-capture system, the general lighting conditions in the area, the sensor noise level, and the expected size, proximity, and reflectivity of the object of interest so as to minimize both false positives and false negatives. In some implementations, suitable settings are determined empirically, e.g., by having a person repeatedly walk into and out of the region of interest 112 and tracking the sensor output to establish a minimum change in brightness associated with the person's entrance into and exit from the region of interest 112. Of course, theoretical and empirical threshold-setting methods can also be used in conjunction. For example, a range of thresholds can be determined based on theoretical considerations (e.g., by physical modelling, which can include ray tracing, noise estimation, etc.), and the threshold thereafter fine-tuned within that range based on experimental observations.

In implementations where the area of interest 112 is illuminated, the sensor(s) 118 will generally, in the absence of an object in this area, only measure scattered light amounting to a small fraction of the illumination light. Once an object enters the illuminated area, however, this object can reflect substantial portions of the light toward the sensor(s) 118, causing an increase in the measured brightness. In some implementations, the sensor(s) 118 is (or are) used in conjunction with the light sources 108, 110 to deliberately measure changes in one or more environmental illumination parameters such as the reflectivity of the environment within the wavelength range of the light sources. The light sources can blink, and a brightness differential be measured between dark and light periods of the blinking cycle. If no object is present in the illuminated region, this yields a baseline reflectivity of the environment. Once an object is in the area of interest 112, the brightness differential will increase substantially, indicating increased reflectivity. (Typically, the signal measured during dark periods of the blinking cycle, if any, will be largely unaffected, whereas the reflection signal measured during the light period will experience a significant boost.) Accordingly, the control system 106 monitoring the output of the sensor(s) 118 can detect an object in the region of interest 112 based on a change in one or more environmental illumination parameters such as environmental reflectivity that exceeds a predetermined threshold (e.g., by 10% or some other relative or absolute amount). As with changes in brightness, the threshold change can be set theoretically based on the configuration of the image-capture system and the monitored space as well as the expected objects of interest, and/or experimentally based on observed changes in reflectivity.

### Computer System

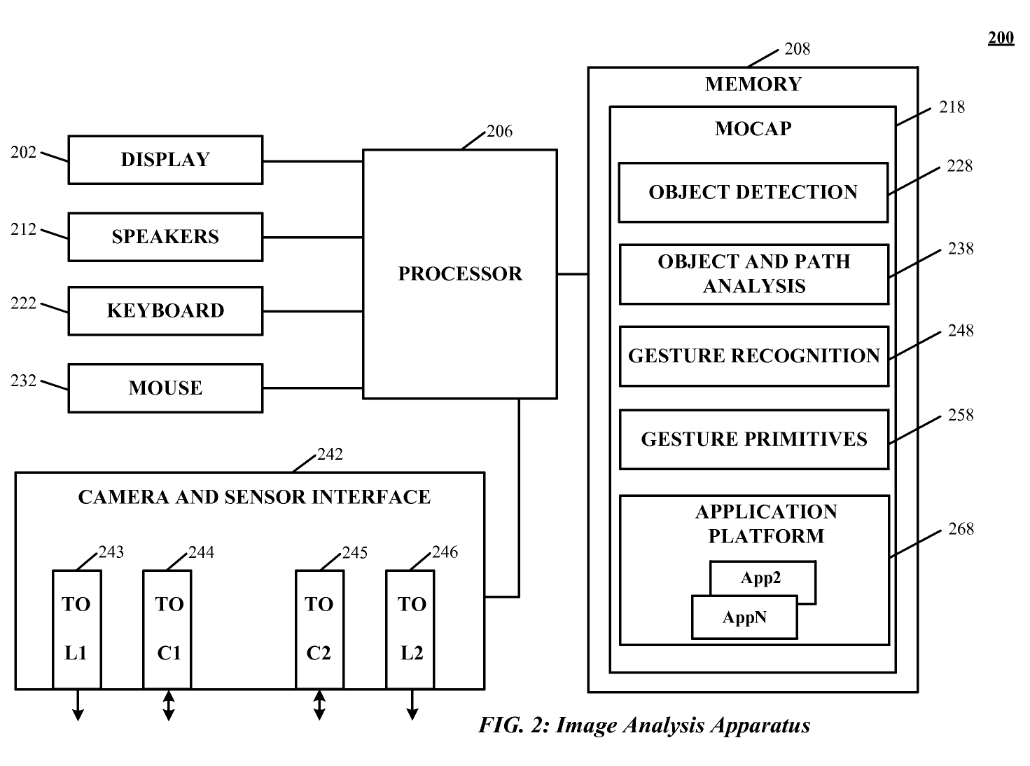

FIG. 2 is a simplified block diagram of a computer system 200, implementing all or portions of image analysis and motion capture system 106 according to an implementation of the technology disclosed. Image analysis and motion capture system 106 can include or consist of any device or device component that is capable of capturing and processing image data. In some implementations, computer system 200 includes a processor 206, memory 208, a sensor interface 242, a display 202 (or other presentation mechanism(s), e.g. holographic projection systems, wearable googles or other head mounted displays (HMDs), heads up displays (HUDs), other visual presentation mechanisms or combinations thereof, speakers 212, a keyboard 222, and a mouse 232. Memory 208 can be used to store instructions to be executed by processor 206 as well as input and/or output data associated with execution of the instructions. In particular, memory 208 contains instructions, conceptually illustrated as a group of modules described in greater detail below, that control the operation of processor 206 and its interaction with the other hardware components. An operating system directs the execution of low-level, basic system functions such as memory allocation, file management and operation of mass storage devices. The operating system can be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MAC OS operating system, the APACHE operating system, an OPENACTION operating system, iOS, Android or other mobile operating systems, or another operating system platform.

The computing environment can also include other removable/non-removable, volatile/nonvolatile computer storage media. For example, a hard disk drive can read or write to non-removable, nonvolatile magnetic media. A magnetic disk drive can read from or write to a removable, nonvolatile magnetic disk, and an optical disk drive can read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid physical arrangement RAM, solid physical arrangement ROM, and the like. The storage media are typically connected to the system bus through a removable or non-removable memory interface.

According to some implementations, cameras 102, 104 and/or light sources 108, 110 can connect to the computer 200 via a universal serial bus (USB), FireWire, or other cable, or wirelessly via Bluetooth, Wi-Fi, etc. The computer 200 can include a camera interface 242, implemented in hardware (e.g., as part of a USB port) and/or software (e.g., executed by processor 206), that enables communication with the cameras 102, 104 and/or light sources 108, 110. The camera interface 242 can include one or more data ports and associated image buffers for receiving the image frames from the cameras 102, 104; hardware and/or software signal processors to modify the image data (e.g., to reduce noise or reformat data) prior to providing it as input to a motion-capture or other image-processing program; and/or control signal ports for transmit signals to the cameras 102, 104, e.g., to activate or deactivate the cameras, to control camera settings (frame rate, image quality, sensitivity, etc.), or the like.

Processor 206 can be a general-purpose microprocessor, but depending on implementation can alternatively be a microcontroller, peripheral integrated circuit element, a CSIC (customer-specific integrated circuit), an ASIC (application-specific integrated circuit), a logic circuit, a digital signal processor, a programmable logic device such as an FPGA (field-programmable gate array), a PLD (programmable logic device), a PLA (programmable logic array), an RFID processor, smart chip, or any other device or arrangement of devices that is capable of implementing the actions of the processes of the technology disclosed.

Camera and sensor interface 242 can include hardware and/or software that enables communication between computer system 200 and cameras such as cameras 102, 104 shown in FIG. 1, as well as associated light sources such as light sources 108, 110 of FIG. 1. Thus, for example, camera and sensor interface 242 can include one or more data ports 244, 245 to which cameras can be connected, as well as hardware and/or software signal processors to modify data signals received from the cameras (e.g., to reduce noise or reformat data) prior to providing the signals as inputs to a motion-capture (“mocap”) program 218 executing on processor 206. In some implementations, camera and sensor interface 242 can also transmit signals to the cameras, e.g., to activate or deactivate the cameras, to control camera settings (frame rate, image quality, sensitivity, etc.), or the like. Such signals can be transmitted, e.g., in response to control signals from processor 206, which can in turn be generated in response to user input or other detected events.

Camera and sensor interface 242 can also include controllers 243, 246, to which light sources (e.g., light sources 108, 110) can be connected. In some implementations, controllers 243, 246 provide operating current to the light sources, e.g., in response to instructions from processor 206 executing mocap program 218. In other implementations, the light sources can draw operating current from an external power supply, and controllers 243, 246 can generate control signals for the light sources, e.g., instructing the light sources to be turned on or off or changing the brightness. In some implementations, a single controller can be used to control multiple light sources.

Instructions defining mocap program 218 are stored in memory 208, and these instructions, when executed, perform motion-capture analysis on images supplied from cameras connected to sensor interface 242. In one implementation, mocap program 218 includes various modules, such as an object detection module 228, an image and/or object and path analysis module 238, and gesture-recognition module 248. Object detection module 228 can analyze images (e.g., images captured via sensor interface 242) to detect edges and/or features of an object therein and/or other information about the object's location. Object and path analysis module 238 can analyze the object information provided by object detection module 228 to determine the 3D position and/or motion of the object (e.g., a user's hand). Examples of operations that can be implemented in code modules of mocap program 218 are described below.

The memory 208 can further store input and/or output data associated with execution of the instructions (including, e.g., input and output image data 248) as well as additional information used by the various software applications. In addition, the memory 208 can also include other information and/or code modules used by mocap program 218 such as an application platform 268, which allows a user to interact with the mocap program 218 using different applications like application 1 (App1), application 2 (App2), and application N (AppN).

Display 202, speakers 212, keyboard 222, and mouse 232 can be used to facilitate user interaction with computer system 200. In some implementations, results of motion capture using sensor interface 242 and mocap program 218 can be interpreted as user input. For example, a user can perform hand gestures that are analyzed using mocap program 218, and the results of this analysis can be interpreted as an instruction to some other program executing on processor 206 (e.g., a web browser, word processor, or other application). Thus, by way of illustration, a user might use upward or downward swiping gestures to “scroll” a webpage currently displayed on display 202, to use rotating gestures to increase or decrease the volume of audio output from speakers 212, and so on.

It will be appreciated that computer system 200 is illustrative and that variations and modifications are possible. Computer systems can be implemented in a variety of form factors, including server systems, desktop systems, laptop systems, tablets, smart phones or personal digital assistants, wearable devices, e.g., goggles, head mounted displays (HMDs), wrist computers, heads up displays (HUDs) for vehicles, and so on. A particular implementation can include other functionality not described herein, e.g., wired and/or wireless network interfaces, media playing and/or recording capability, etc. In some implementations, one or more cameras can be built into the computer or other device into which the sensor is imbedded rather than being supplied as separate components. Further, an image analyzer can be implemented using only a subset of computer system components (e.g., as a processor executing program code, an ASIC, or a fixed-function digital signal processor, with suitable I/O interfaces to receive image data and output analysis results).

In another example, in some implementations, the cameras 102, 104 are connected to or integrated with a special-purpose processing unit that, in turn, communicates with a general-purpose computer, e.g., via direct memory access (“DMA”). The processing unit can include one or more image buffers for storing the image data read out from the camera sensors, a GPU or other processor and associated memory implementing at least part of the motion-capture algorithm, and a DMA controller. The processing unit can provide processed images or other data derived from the camera images to the computer for further processing. In some implementations, the processing unit sends display control signals generated based on the captured motion (e.g., of a user's hand) to the computer, and the computer uses these control signals to adjust the on-screen display of documents and images that are otherwise unrelated to the camera images (e.g., text documents or maps) by, for example, shifting or rotating the images.

While computer system 200 is described herein with reference to particular blocks, it is to be understood that the blocks are defined for convenience of description and are not intended to imply a particular physical arrangement of component parts. Further, the blocks need not correspond to physically distinct components. To the extent that physically distinct components are used, connections between components (e.g., for data communication) can be wired and/or wireless as desired.

With reference to FIGS. 1 and 2, the user performs a gesture that is captured by the cameras 102, 104 as a series of temporally sequential images. In other implementations, cameras 102, 104 can capture any observable pose or portion of a user. For instance, if a user walks into the field of view near the cameras 102, 104, cameras 102, 104 can capture not only the whole body of the user, but the positions of arms and legs relative to the person's core or trunk. These are analyzed by the mocap 218, which provides input to an electronic device, allowing a user to remotely control the electronic device and/or manipulate virtual objects, such as prototypes/models, blocks, spheres, or other shapes, buttons, levers, or other controls, in a virtual environment displayed on display 202. The user can perform the gesture using any part of her body, such as a finger, a hand, or an arm. As part of gesture recognition or independently, the image analysis and motion capture system 106 can determine the shapes and positions of the user's hand in 3D space and in real time; see, e.g., U.S. Ser. Nos. 61/587,554, 13/414,485, 61/724,091, and Ser. No. 13/724,357 filed on Jan. 17, 2012, Mar. 7, 2012, Nov. 8, 2012, and Dec. 21, 2012 respectively, the entire disclosures of which are hereby incorporated by reference. As a result, the image analysis and motion capture system processor 206 may not only recognize gestures for purposes of providing input to the electronic device, but can also capture the position and shape of the user's hand in consecutive video images in order to characterize the hand gesture in 3D space and reproduce it on the display screen 202.

In one implementation, the mocap 218 compares the detected gesture to a library of gestures electronically stored as records in a database, which is implemented in the image analysis and motion capture system 106, the electronic device, or on an external storage system. (As used herein, the term “electronically stored” includes storage in volatile or non-volatile storage, the latter including disks, Flash memory, etc., and extends to any computationally addressable storage media (including, for example, optical storage).) For example, gestures can be stored as vectors, i.e., mathematically specified spatial trajectories, and the gesture record can have a field specifying the relevant part of the user's body making the gesture; thus, similar trajectories executed by a user's hand and head can be stored in the database as different gestures so that an application can interpret them differently. Typically, the trajectory of a sensed gesture is mathematically compared against the stored trajectories to find a best match, and the gesture is recognized as corresponding to the located database entry only if the degree of match exceeds a threshold. The vector can be scaled so that, for example, large and small arcs traced by a user's hand will be recognized as the same gesture (i.e., corresponding to the same database record) but the gesture recognition module will return both the identity and a value, reflecting the scaling, for the gesture. The scale can correspond to an actual gesture distance traversed in performance of the gesture, or can be normalized to some canonical distance.

In various implementations, the motion captured in a series of camera images is used to compute a corresponding series of output images for presentation on the display 202. For example, camera images of a moving hand can be translated by the processor 206 into a wire-frame or other graphical representations of motion of the hand. In any case, the output images can be stored in the form of pixel data in a frame buffer, which can, but need not be, implemented, in main memory 208. A video display controller reads out the frame buffer to generate a data stream and associated control signals to output the images to the display 202. The video display controller can be provided along with the processor 206 and memory 208 on-board the motherboard of the computer 200, and can be integrated with the processor 206 or implemented as a co-processor that manipulates a separate video memory.

In some implementations, the computer 200 is equipped with a separate graphics or video card that aids with generating the feed of output images for the display 202. The video card generally includes a graphical processing unit (“GPU”) and video memory, and is useful, in particular, for complex and computationally expensive image processing and rendering. The graphics card can implement the frame buffer and the functionality of the video display controller (and the on-board video display controller can be disabled). In general, the image-processing and motion-capture functionality of the system 200 can be distributed between the GPU and the main processor 206.

In some implementations, the gesture-recognition module 248 detects more than one gesture. The user can perform an arm-waving gesture while flexing his or her fingers. The gesture-recognition module 248 detects the waving and flexing gestures and records a waving trajectory and five flexing trajectories for the five fingers. Each trajectory can be converted into a vector along, for example, six Euler degrees of freedom in Euler space. The vector with the largest magnitude can represent the dominant component of the motion (e.g., waving in this case) and the rest of vectors can be ignored. In one implementation, a vector filter that can be implemented using conventional filtering techniques is applied to the multiple vectors to filter the small vectors out and identify the dominant vector. This process can be repetitive, iterating until one vector—the dominant component of the motion—is identified. In some implementations, a new filter is generated every time new gestures are detected.

If the gesture-recognition module 248 is implemented as part of a specific application (such as a game or controller logic for a television), the database gesture record can also contain an input parameter corresponding to the gesture (which can be scaled using the scaling value); in generic systems where the gesture-recognition module 248 is implemented as a utility available to multiple applications, this application-specific parameter is omitted: when an application invokes the gesture-recognition module 248, it interprets the identified gesture according in accordance with its own programming.

In one implementation, the gesture-recognition module 248 breaks up and classifies one or more gestures into a plurality of gesture primitives. Each gesture can include or correspond to the path traversed by an object, such as user's hand or any other object (e.g., an implement such as a pen or paintbrush that the user holds), through 3D space. The path of the gesture can be captured by the cameras 102, 104 in conjunction with mocap 218, and represented in the memory 208 as a set of coordinate (x,y,z) points that lie on the path, as a set of vectors, as a set of specified curves, lines, shapes, or by any other coordinate system or data structure. Any method for representing a 3D path of a gesture on a computer system is within the scope of the technology disclosed.

Each primitive can be a curve, such as an arc, parabola, elliptic curve, or any other type of algebraic or other curve. The primitives can be two-dimensional curves and/or three-dimensional curves. In one implementation, a gesture-primitives module 158 includes a library of gesture primitives and/or parameters describing gesture primitives. The gesture-recognition module 248 can search, query, or otherwise access the gesture primitives by applying one or more parameters (e.g., curve size, shape, and/or orientation) of the detected path (or segment thereof) to the gesture-primitives module 158, which can respond with one or more closest-matching gesture primitives.

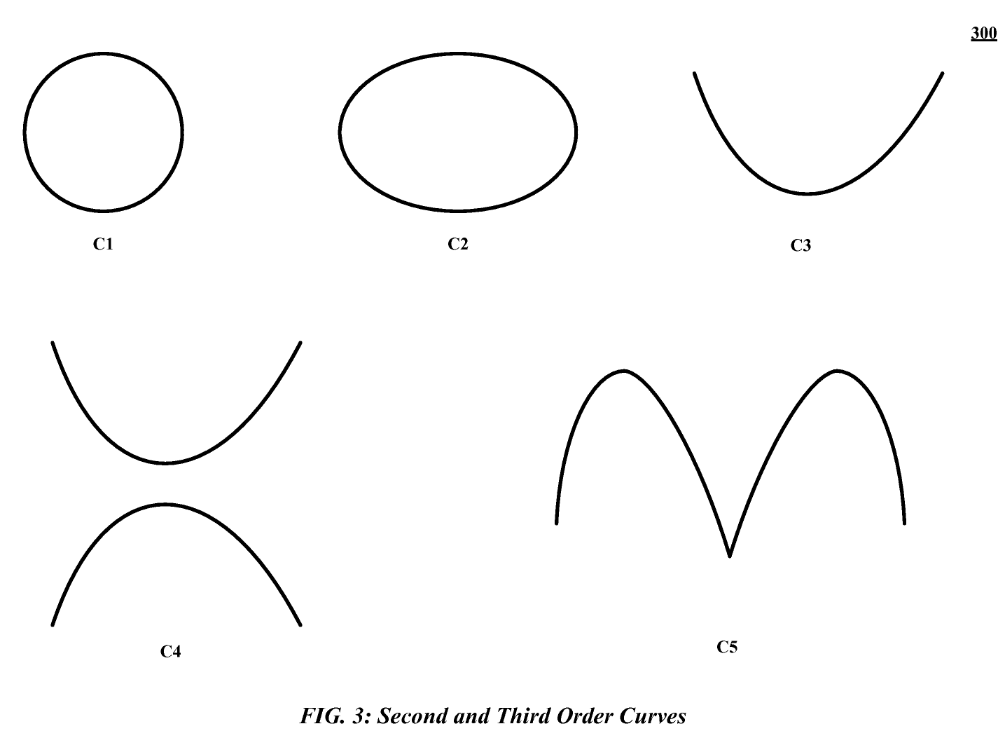

FIG. 3 shows one implementation of exemplary second and third order curves 300. In particular, curve C1 is a circle, C2 is an ellipse, C3 is a parabola, and C4 is a hyperbola, all representing second order curves or quadratic curves. In one implementation, a quadratic curve is a parametric curve defined by three control points (P0, P1, P2) in a plane or in three-dimensional (3D) space. Starting at P0 and ending at P2, the curve is influenced by the position of an additional control point P1. A rational quadratic curve is a quadratic curve defined by a rational fraction of quadratic polynomials. Curve C5 is a curve of the third order, or cubic curve. A cubic curve is a parametric curve defined by four control points. A cubic curve can be represented by two or more quadratic curves, although in some cases a cubic curve can be represented using only one quadratic curve (such as the degenerate case where the cubic is itself a line or a quadratic). In other implementations, curves of fourth order or higher can be defined and stored for further processing.

### Gesture Primitives

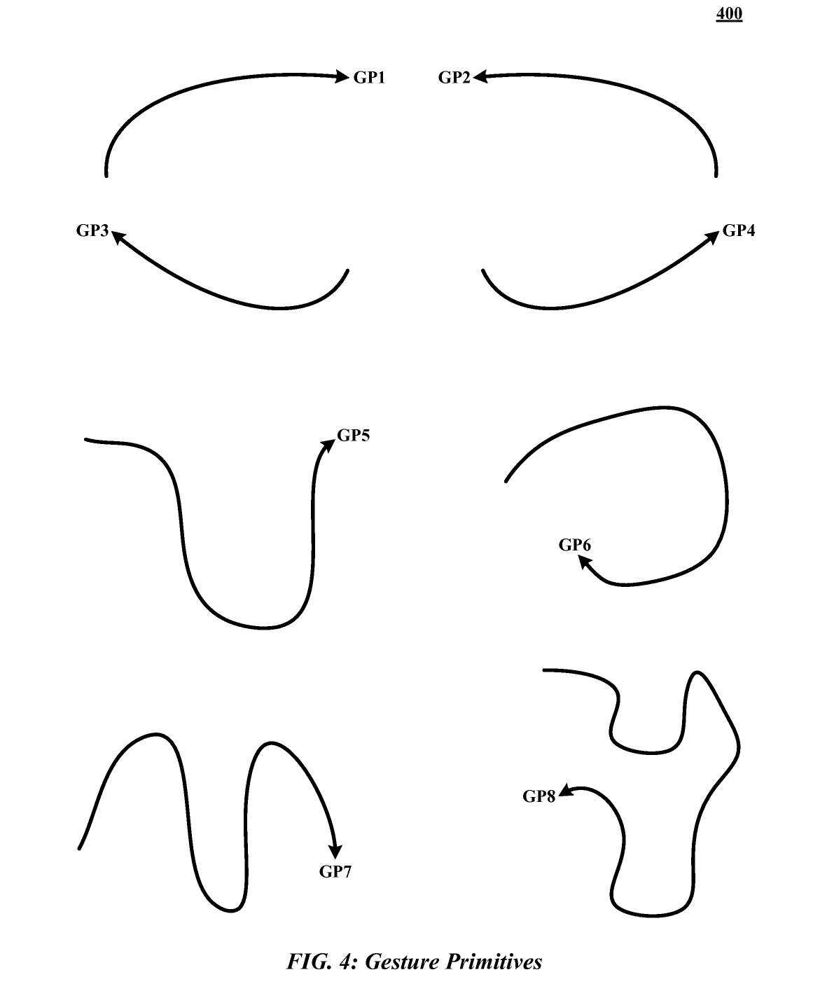

FIG. 4 illustrates one implementation of a template library 400 of gesture primitives used to decompose detected gestures of a control object. In particular, template library 400 includes parabolic gesture primitives GP1-GP4 and cubic gesture primitives GP5-GP8. Gesture primitives are gesture components rather than complete gestures that are collectively stored as template library 400 in gesture primitives 258. In other implementations, template library 400 may not have the same gesture primitives or geometric shapes as those listed above and/or may have other/different gesture primitives or geometric shapes instead of, or in addition to, those listed above, such as diagonals, quarter-circles, or second, third, fourth, or higher order curves.

According to some implementations, the stored gesture primitives have a curvilinear local coordinate system and therefore the detected gestural paths are first transformed to a curvilinear coordinate system prior to being matched to the gesture primitives, as described below. In one implementation, an object detection module 228 identifies a set of Cartesian/(x,y,z) coordinates that represent the changing locations of an object as it traverses a path through a monitored space. The object detection module 228 identifies these coordinates by analyzing the position of the object as captured in a sequence of images. A filtering module receives the Cartesian coordinates, converts the path of the object into curvilinear coordinates and/or Frenet-Serret frame, and filters the path in that space. In one implementation, the filtering module then converts the curvilinear coordinates and/or Frenet-Serret frame back into Cartesian coordinates for downstream processing by other programs, applications, modules, or systems.

According to some implementations, a gestural path of a control object can be entirely defined by its angles in the relative curvilinear coordinates. In one example, if C is a vector representing the control object in the Cartesian coordinate system as C(x,y,z)=(initial point−final point) (x,y,z). Then, transformation to a curvilinear coordinate system can be denoted as C(ρ, θ, φ), where ρ represents the radius of a curve, θ is the azimuth angle of the curve, and φ is the inclination angle of the curve.

### Jacobian of a Transformation

In yet another implementation, any plane having ordinary Cartesian coordinates in a standard 3D space can be transformed by an invertible 3×3 matrix using homogeneous coordinates in a curvilinear space. In one implementation, a set of physical Cartesian coordinates (x,y,z,t) can be transformed to curvilinear coordinates using the following independent variables (1) such that a matrix form (2) is generated via the chain rule:

$$\begin{matrix}x = x ( ξ , η , ζ , t ) \\ y = y ( ξ , η , ζ , t ) \\ z = z ( ξ , η , ζ , t ) & ( 1 ) \\ ( \begin{matrix}\frac{\partial u}{\partial x} & \frac{\partial u}{\partial y} & \frac{\partial u}{\partial z} \\ \frac{\partial v}{\partial x} & \frac{\partial v}{\partial y} & \frac{\partial v}{\partial z} \\ \frac{\partial w}{\partial x} & \frac{\partial w}{\partial y} & \frac{\partial w}{\partial z}\end{matrix} ) = ( \begin{matrix}\frac{\partial u}{\partial ξ} & \frac{\partial u}{\partial η} & \frac{\partial u}{\partial ζ} \\ \frac{\partial v}{\partial ξ} & \frac{\partial v}{\partial η} & \frac{\partial v}{\partial ζ} \\ \frac{\partial w}{\partial ξ} & \frac{\partial w}{\partial η} & \frac{\partial w}{\partial ζ}\end{matrix} ) ( \begin{matrix}\frac{\partial ξ}{\partial x} & \frac{\partial ξ}{\partial y} & \frac{\partial ξ}{\partial z} \\ \frac{\partial η}{\partial x} & \frac{\partial η}{\partial y} & \frac{\partial η}{\partial z} \\ \frac{\partial ζ}{\partial x} & \frac{\partial ζ}{\partial y} & \frac{\partial ζ}{\partial z}\end{matrix} ) & ( 2 )\end{matrix}$$

Further, in one implementation, a Jacobian matrix can be used to map variables from a Cartesian reference system to a curvilinear reference system. A Jacobian matrix (3) of the transformation is represented as follows:

$$[ J ] = ( \begin{matrix}\frac{\partial ξ}{\partial x} & \frac{\partial ξ}{\partial y} & \frac{\partial ξ}{\partial z} \\ \frac{\partial η}{\partial x} & \frac{\partial η}{\partial y} & \frac{\partial η}{\partial z} \\ \frac{\partial ζ}{\partial x} & \frac{\partial ζ}{\partial y} & \frac{\partial ζ}{\partial z}\end{matrix} ) \qquad ( 3 )$$

In another implementation, an inverse Jacobian matrix (4) depicted below can be used to map Cartesian coordinates to curvilinear coordinates.

$${[ J ]}^{- 1} = ( \begin{matrix}\frac{\partial x}{\partial ξ} & \frac{\partial x}{\partial η} & \frac{\partial x}{\partial ζ} \\ \frac{\partial y}{\partial ξ} & \frac{\partial y}{\partial η} & \frac{\partial y}{\partial ζ} \\ \frac{\partial z}{\partial ξ} & \frac{\partial z}{\partial η} & \frac{\partial z}{\partial ζ}\end{matrix} ) \qquad ( 4 )$$

### Helix Transformation

In yet some other implementation, a helix defined by position vectors with Cartesian coordinates can be converted into the orthonormal vectors tangent, normal, and/or binomial direction of a curvilinear Frenet-Serret frame, as shown in the example below worked out in a mathematics software such as MapleSoft™:

SetCoordinates(cartesian[x,y,z]):

R:=PositionVector([a cos(p),a sin(p),p])

$$R := [ \begin{matrix}a cos ( p ) \\ a sin ( p ) \\ ( p )\end{matrix} ]$$

According to one implementation, the tangent-normal-binormal frame is obtained with:

$$simplify ( [ T N B Frame ( R , p ) ] ) \\ [ [ \begin{matrix}- \frac{a sin ( p )}{\sqrt{1 + {a}^{2}}} \\ \frac{a cos ( p )}{\sqrt{1 + {a}^{2}}} \\ \frac{1}{1 + {a}^{2}}\end{matrix} ] , [ \begin{matrix}- cos ( p ) \\ - sin ( p ) \\ 0\end{matrix} ] , [ \begin{matrix}\frac{sin ( p )}{\sqrt{1 + {a}^{2}}} \\ - \frac{cos ( p )}{\sqrt{1 + {a}^{2}}} \\ \frac{a}{\sqrt{1 + {a}^{2}}}\end{matrix} ] ]$$

In one implementation, the curvature for the Frenet-Serret frame is obtained as:

$$simplify ( Curvature ( R , p ) )$$

$$\frac{a}{1 + {a}^{2}}$$

In one implementation, the torsion for the Frenet-Serret frame is obtained as:

$$simplify ( Torsion ( R , p ) )$$

$$\frac{1}{1 + {a}^{2}}$$

### Complex Gesture Interpretation

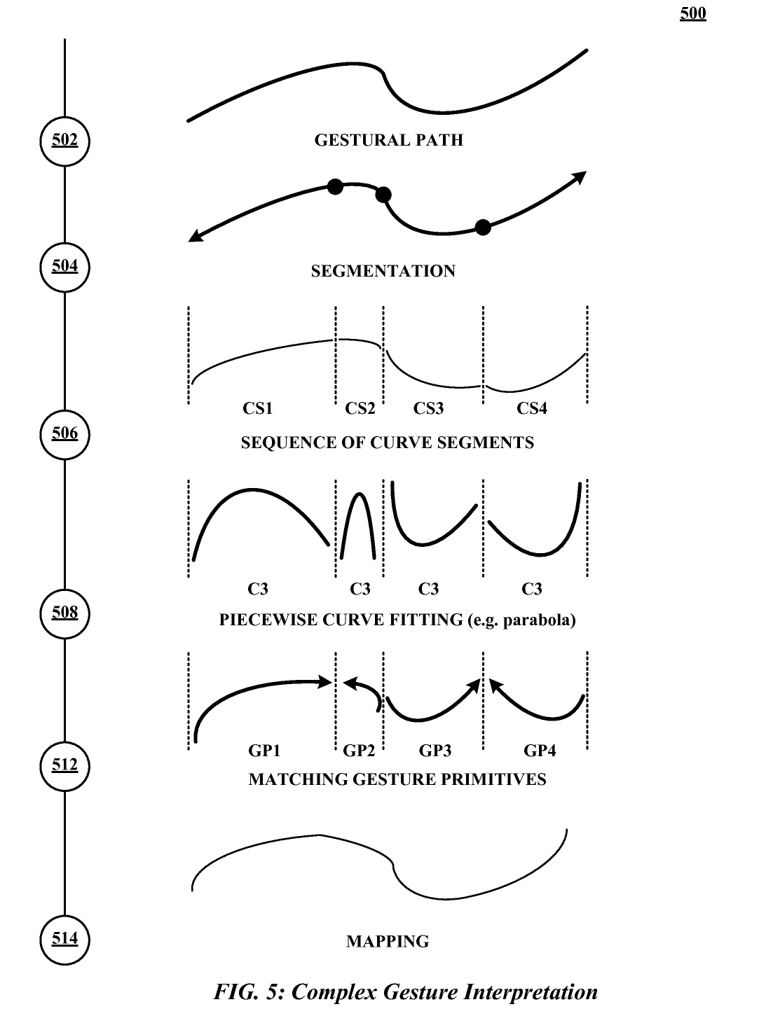

FIG. 5 depicts one implementation of complex gesture interpretation 500. In operation, according to one implementation, gestural path 502 is first segmented or sub-adivided 504 at vertices and inflection points (depicted by dots) to generate four curve segments CS1, CS2, CS3, and CS4. As a result, from a quadratic curve 502 with two vertices and three additional inflection points, multiple quadratic curves CS1-CS4 are derived that approximate the original curve 502. In one implementation, a “flattening” technique can be used to break the curve 502 it into a series of line segments that approximate the shape of the original curve 502. Though FIG. 5 shows the mapping 514 of only four primitives, implementations of the technology disclosed can map an arbitrarily high number of primitives, in 2D and 3D space, to arbitrarily long gesture paths.

After segmentation 504, the derived curve segments CS1, CS2, CS3, and CS4 are arranged in a sequence 506 representing the original curve 502 so as to facilitate piecewise fitting 508 of second and/or third order curves into the respective curve segments CS1, CS2, CS3, and CS4. In the example shown in FIG. 5, second order parabolic curves are respectively fit into all four curve segments CS1, CS2, CS3, and CS4. As depicted in FIG. 5, the selection, orientation, size, inclination angle, or azimuth angle of the fitted curves varies depending on the shape of the curve segment they are being fitted into.

Once the curve segments CS1, CS2, CS3, and CS4 are identified with at least one second or third order curve, their fitted geometric constructs are matched with pre-defined gesture primitives stored in the template library 400. Once the matched gesture primitives are specified, one or more geometric attributes of the curve segments CS1, CS2, CS3, and CS4 are modified to best replicate corresponding parameters of the matched gesture primitives so as to effectuate a best-fitted or interpolated curve 514 that collectively approximates the original curve 502 with each of its individual curve segments representing at least one pre-defined gesture primitive.

In one implementation, gesture-recognition module 248 can analyze the path 502 of the gesture through 3D space in order to identify segments thereof likely to correspond to gesture primitives. For example, the gesture-recognition module 248 can analyze the geometry of the path 502 in order to identify vertices, inflection points, a gradient or other vector property, or other geometric attributes relating to the shape of the path, and primitives based on (e.g., bounded or defined by) these identified segments are found in the library and mapped to the path accordingly. Of course, segments of the path 502 may not conform precisely to Euclidean curves; accordingly, the path 502 can be filtered (e.g., smoothed) and segments corresponding approximately to predefined geometric constructs within an error limit are treated as conforming thereto for mapping purposes. For example, best-fit parabolas can be mapped to the path such the vertices of the parabolas correspond to vertices in the path, and the parabolas terminate at the inflection points of the path, so long as the best-fit parabolas do not deviate from the traced path 502 by more than an error limit as discussed below. In other implementations, primitives can be assigned to segments of the path that have local-maximum gradients. The path can alternatively or in addition be broken up into equal- or variable-sized segments that are analyzed against the library for matching entries; if a match is found (again, within an error limit), the corresponding primitive is assigned to the segment. The primitives can be mapped to the path such that the entire path is represented by the primitives (e.g., each point along the path has a corresponding primitive) by ensuring that the library of primitives is rich enough to include primitives corresponding, at least approximately, to virtually any segment; in other implementations, primitives are mapped to only a subset of the path (segments at which, for example, the path changes its direction or curvature, or where the degree of match to a limited number of stored primitives is sufficient).

Thus, mapping of the primitives can include placing and adjusting a curve to a segment of the path to best approximate that segment of the path. For example, a parabola can be defined to map to a segment of the path by adjusting its size, curvature, and orientation in 3D space to approximate the given segment of the path. The curve can be deemed suitable if, by adjusting its available parameters, the difference between the curve and the segment of the path falls below a maximum allowable error. For example, a plurality of distances between the curve and the segment of the path can be computed in coordinate (x,y,z) space for a plurality of points along the curve and the segment of the path; if the total or average length of the distances is less than an allowed maximum, the curve is deemed to match the segment of the path. In another implementation, the surface of the 2D area between the curves is computed and similarly compared to a maximum allowable area.

Each segment of the path or a subset thereof can thus be mapped to a curve. In one implementation, if one or more segments of the path cannot be satisfactorily mapped to a curve (if, e.g., the error between the curve and the segment of the path exceeds a maximum threshold), different types of curves can be applied to the segment. Alternatively or in addition, the failing segment of the path can be grown, shrunk, split, or shifted (and the rest of the segments of the path adjusted as necessary), and the gesture-recognition module 248 can attempt to fit curves to the adjusted segments.

In a different implementation, a reference Frenet-Serret frame can be associated with various points along the path 502, and the rotation between consecutive frames can be determined using the Frenet-Serret formulas describing curvature and torsion. The total rotation of the Frenet-Serret frame is the combination of the rotations of each of the three Frenet vectors described by the formulas

$$\frac{d T}{d s} = κ N , \frac{d N}{d s} = - κ T + τ B , \\ and$$

$$\frac{d B}{d s} = - τ N , \\ where$$

$$\frac{d}{d s}$$

is the derivative with respect to arclength, κ is the curvature, and τ is the torsion of the curve. The two scalars κ and τ can define the curvature and torsion of a 3D curve, in that the curvature measures how sharply a curve is turning while torsion measures the extent of its twist in 3D space. Alternatively, the curvature and torsion parameters can be calculated directly from the derivative of best-fit curve functions (i.e., velocity) using, for example, the equations

$$κ = \frac{\vert {v}^{->} \times {a}^{->} \vert}{{\vert {v}^{->} \vert}^{3}} and τ = \frac{( {v}^{->} \times {a}^{->} ) \cdot {a}^{->} ′}{{\vert {v}^{->} \times {a}^{->} \vert}^{2}} .$$

In various implementations, the gesture-primitives module 258 can extract additional properties from the path 502 of the gesture and use these to map the primitives. For example, the path 502 of the gesture can be analyzed to determine the torsion of the path at one or more points therealong; the gesture-primitives library can contain torsion information related to each stored primitive, and torsion can thereby be used to map detected primitives to library entries. In another implementation, the velocity of the object making the path is tracked and included in the path or in any other data structure; stored gesture primitives can be specified by velocity in addition to geometry, and this information can be further used to map the primitives (e.g., two primitives can be similar in curvature/torsion but can differ in speed).

Accordingly, the gesture-primitives module 258 can map curves to each identified segment of a path 502 and attempt to identify gesture primitives corresponding to the curves, or, instead of first fitting curves to the path, the gesture-recognition module 248 can apply the stored gesture primitives directly to segments of the path 502 identified by the gesture-primitives module 258 to find one or more matching primitives for each identified path segment. For example, the gesture-recognition module 248 can cycle through all or a subset of the gesture primitives supplied by the gesture-primitives module 258 for each segment of the path to find the closest-matching primitive(s).

As explained above, some or all of the primitives supplied by the gesture-primitives module 258 can be adjusted within certain parameters to better approximate segments of the path. For example, a parabola primitive can match a segment of the path with respect to its curvature but differ in terms of size or orientation. These parameters can be adjusted to better match the primitive to the segment of the path (or can be ignored when matching the primitive to the segment of the path). Different primitives can have different adjustable/ignorable parameters, and, further, the adjustable/ignorable parameters can differ for different users, applications, or contexts.

The gesture-recognition module 248 can add or delete primitives to or from the library of the gesture-primitives module 258. For example, if a given parameter never (or rarely) matches segments of the path, it can be removed. A gesture primitive can also be removed if it is frequently in conflict with another primitive (i.e., a segment of the path is mapped to two or more primitives with no clear better primitive) but is ultimately discarded in favor of another primitive (as explained in further detail below). The gesture-recognition module 248 can add a primitive to the library of the gesture-primitives module 258 to map to frequently occurring types of path segments that do not map to any other primitives. In this case, the gesture-recognition module 248 can analyze the types of the unmatched segments to characterize them into a new primitive. In one implementation, the gesture-primitives module 258 contains a number of generic primitives that apply to all (or a subset) users and applications, and the gesture-recognition module 248 builds up a custom library of gesture primitives on a per-user or per-application basis by adding new primitives.

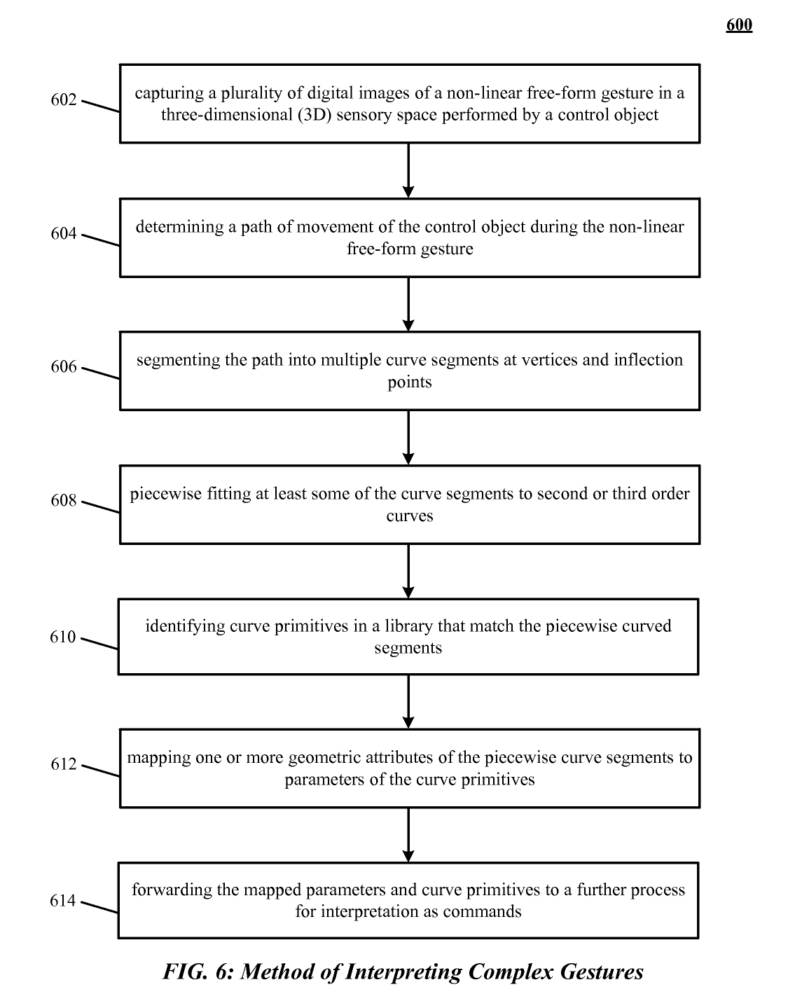

FIG. 6 is a flowchart 600 showing a method of interpreting complex gestures. Flowchart 600 can be implemented at least partially with a database system, e.g., by one or more processors configured to receive or retrieve information, process the information, store results, and transmit the results. Other implementations may perform the actions in different orders and/or with different, fewer or additional actions than those illustrated in FIG. 6. Multiple actions can be combined in some implementations. For convenience, this flowchart is described with reference to the system that carries out a method. The system is not necessarily part of the method.

At action 602, a plurality of digital images of a non-linear free-form gesture is captured in a three-dimensional (3D) sensory space performed by a control object.

At action 604, a path of movement of the control object during the non-linear free-form gesture is determined.

At action 606, the path is segmented into multiple curve segments at least one of vertices, mid-points, and inflection points.

At action 608, at least some of the curve segments are piecewise fitted to second or third order curves.

At action 610, curve parameters that match the piecewise curved segments are identified.

At action 612, one or more geometric attributes of the piecewise curve segments are mapped to the parameters of the curve primitives. According to one implementation, mapping geometric attributes of the curve segments to parameters of the curve segments further includes approximating a best-fit curve for the curve segments. In one implementation, the geometric attributes of the curve segments include at least starting and ending points of the curve segments. In another implementation, the geometric attributes of the curve segments include at least degrees of curvature of the curve segments. In some implementations, the geometric attributes of the curve segments include at least torsion of the curve segments. In other implementations, the geometric attributes of the curve segments include at least gradients of the curve segments. In yet other implementations, the geometric attributes of the curve segments include at least orientation of the curve segments. In a further implementation, the geometric attributes of the curve segments include at least radius of the curve segments.

At action 614, the mapped parameters and curve primitives are forwarded to a further process for interpretation as commands.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations in sections of this application such as motion-capture system, computer system, gesture primitives, complex gesture interpretation, etc.

In a further implementation, method 600 further includes mapping one or more kinematic attributes of the curve segments to parameters of the curve primitives. Examples of kinematic attributes include at least one of speed, velocity, and acceleration of the control object during respective curve segments of the free-form gesture, according to one implementation.

Method 600 further includes anticipating a future motion of the control object based on comparing a sequence of curve primitives mapped to the curve segments to a pre-defined ordering of curve primitives that includes the mapped curve primitives, according to one implementation.

Some other implementations of the method 600 further include determining control manipulations responsive to the free-form gesture by representing the control manipulations as unique gesture-tag sequences and responsive to identifying a subset of the unique gesture-tag sequences in the sequence of curve primitives mapped to the curve segments, performing the control manipulations represented by the subset.

Yet other implementations of the method 600 further include detecting erroneous interpretation of the free-form gesture by representing a first sequence of curve primitives mapped to a first set of curve segments as a first gesture-tag sequence, based on a gesture template that specifies at least one of temporal sequence and combination of gestural-tags representing occurrences of curve segments in a gestural path, identifying a potential gestural-tag sequence that represents a subsequent sequence of curve primitives to be mapped to a future set of curve segments that most likely follow the first set of curve segments, and detecting an erroneous fitting of the curve segments when a second gesture-tag sequence representing a second set of curve segments following the first set of curve segments differs from the potential gestural-tag sequence above a maximum threshold.

Other implementations can include a non-transitory computer readable storage medium storing instructions executable by a processor to perform any of the methods described above. Yet another implementation can include a system including memory and one or more processors operable to execute instructions, stored in the memory, to perform any of the methods described above.

### Automated Gesture Detection Correction

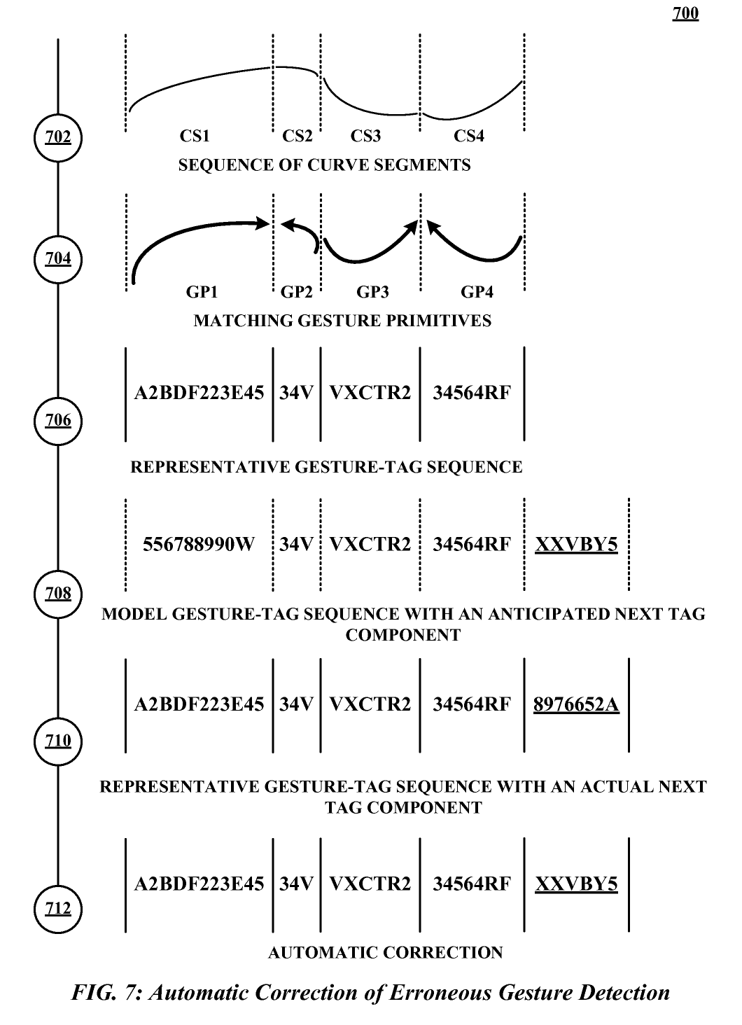

FIG. 7 is one implementation of detecting erroneous interpretation of a gesture. In operation, a sequence 702 of curve segments CS1-CS4 is mapped to predefined geometric constructs i.e. stored gesture primitives 704. Further, the mapped gesture primitives 704 are represented by a sequence of gesture-tags 706, which include unique alphanumeric characters. In representative gesture-tag sequence 706, alphanumeric characters “A2BDF223E45” correspond to gesture primitive GP1, alphanumeric characters “34V” correspond to gesture primitive GP2, alphanumeric characters “A2BDF223E45” correspond to gesture primitive GP3, and alphanumeric characters “A2BDF223E45” correspond to gesture primitive GP4.

Also, a model gesture-tag sequence 708 is a pre-defined gesture construct that specifies different gesture primitives and their representative gesture-tag values of a model gesture. In one implementation, a gesture is determined to be a model gesture when its frequency of detection crosses a threshold value. In another implementation, a gesture qualifies as a model gesture and is represented by a model gesture-tag sequence in response to human designation.

According to some implementations, a representative gesture-tag sequence 706 of actual gesture-primitives can include a similarly ordered subset of a model gesture-tag sequence. For instance, as shown in FIG. 7, only the last three gesture-tags of model gesture-tag sequence 708 match the last three entries of representative gesture tag sequence 706. In addition, based on the model gesture-tag sequence 708, an anticipated next component for the representative gesture-tag sequence of actual gesture-primitives is identified and compared to the corresponding actual value registered for a subsequently mapped gesture primitive.

In the example shown in FIG. 7, the anticipated gesture-tag valued “XXVBY5” is not the same as the corresponding actual gesture tag, which is valued as “8976652A.” As a result, an error is detected and automatically corrected by registering 712 the correct and more reliable anticipated gesture-tag value “XXVBY5” for further interpretation as commands, instead of the actual next tag component t “8976652A” that does not match the anticipated next component derived from the model gesture-tag sequence.

The gesture-recognition module 248 can recognize patterns in the sequence of primitives mapped to the path of the gesture and can characterize the gesture, correct errors in the sequence, or predict future motion of the object making the gesture based on the sequence. In one implementation, each gesture in the gesture-primitives module 258 is assigned a unique, identifying tag, such as alphanumeric strings, numbers, currency, data/time, autonumbers, or Boolean. The path 502 can then be represented as a sequence of gesture tags.

The sequence of gesture tags can be used to characterize the gesture (i.e., determine the user command associated with the gesture). The gesture-recognition module 248 can include or communicate with a database (organized, for example, in the form of a look-up table) that associates gesture-tag sequences with corresponding commands, actions, or other manifestation of user intent (collectively, “user input”), and when a match is found, the user input entry associated with the gesture is utilized—e.g., by passing it to an application, by directly taking an action, by causing one or more graphical items to be rendered on a display screen etc. The gesture-recognition module 248 can also identify a smaller sequence within the full sequence of gesture tags associated with the path of the gesture and characterize the gesture based only on the smaller sequence. In one implementation, the smaller sequence is unique to only one gesture-related command. For example, if the gesture is a button-press gesture (i.e., a user moves his or her index finger toward the screen 138 and then back away from the screen 138), the entire gesture-tag sequence can include primitives related to the total motion of the finger, while the smaller sequence can include only the portion of the gesture at which the user slows, stops, and reverses motion of his or her finger. This smaller sequence can thus be enough to identify the gesture as a button-press gesture.

In one implementation, the gesture-recognition module 248 includes a list of possible or likely gesture-tag sequences for anticipated gestures. As an analogy, the gesture tags are similar to English letters, and the entire gesture-tag sequence is similar to a sentence written in English. Within this “sentence,” there are “words” (i.e., smaller groups of letters). Just as the English language has rules for spelling, the gesture tags can have rules relating to their combination and sequence. For example, given a sequence of five gesture tags, the possibilities for the next, sixth tag can be restricted by rule to only a subset of all of the available tags (just as, in English, only certain letters can follow other letters within the rules of spelling). One reason for these restrictions in the “spelling” of gesture tags are the limitations on real-world motion; a user cannot reverse motion in a gesture path without slowing, stopping, and/or turning the object making the path, for example, so a sequence of gesture tags related to this gesture must include primitives related to the change in direction.

The gesture tags can have rules of “grammar,” as well—if a user makes a gesture that includes a first sequence of gesture tags, for example, the rest of the gesture can be required to include a second sequence of tags (and/or may not be allowed to include the second sequence. Again referring to the natural-language analogy, just as English has subjects, verbs, adjectives, and rules for using them, the gesture-recognition module 248 can include similar rules for identifying sequences of gesture tags and their relationships to each other. For example, if a user throws an object in the air, the first sequence of tags can relate to the throwing and/or rise of the object, and the second, required sequence can be tags related to the object falling from the air.

The gesture-recognition module 248 can use these rules of “spelling” and “grammar” to correct potential errors in the sequence of gesture tags (by, e.g., eliminating tags that violate a rule) and thereby better characterize the gesture. If the gesture-recognition module 248 is unable to uniquely identify a segment of the path of the gesture as mapping to a single primitive, the rules of “spelling” and “grammar” can be used to eliminate all but one primitive. The gesture-recognition module 248 can also use the rules of “spelling” and “grammar” to predict future motion of the object making the gesture by recognizing future gesture tags that are required or likely to occur given an already mapped sequence of gesture tags.

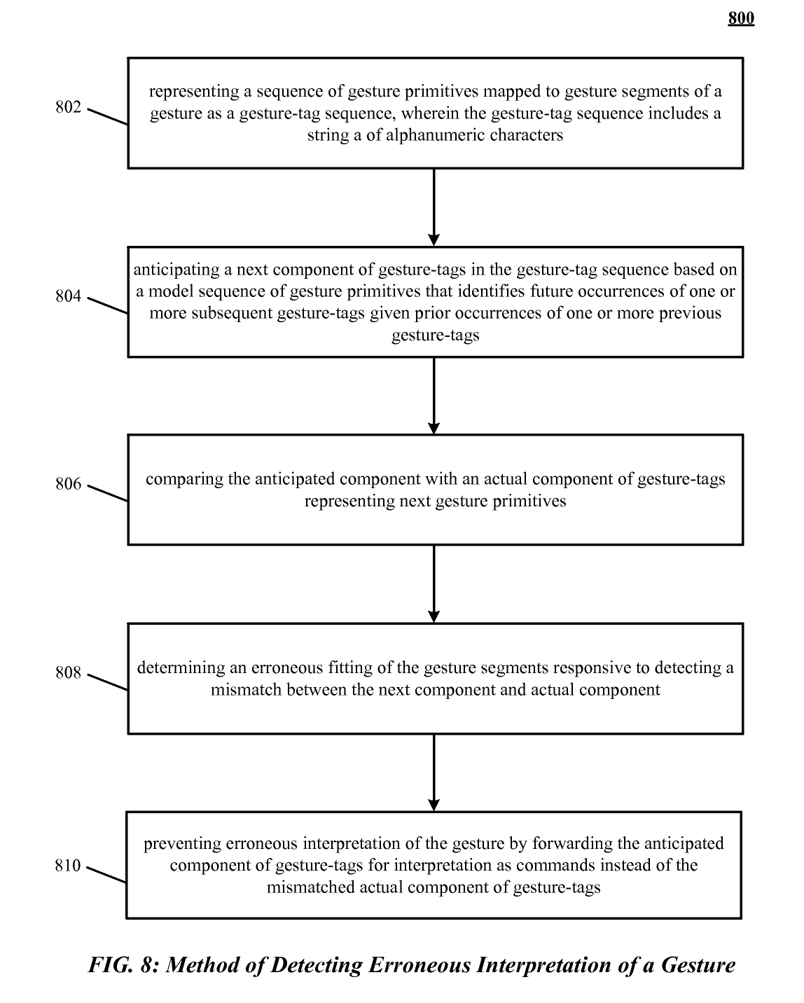

FIG. 8 is a representative method 800 of detecting erroneous interpretation of a gesture. Flowchart 800 can be implemented at least partially with a database system, e.g., by one or more processors configured to receive or retrieve information, process the information, store results, and transmit the results. Other implementations may perform the actions in different orders and/or with different, fewer or additional actions than those illustrated in FIG. 8. Multiple actions can be combined in some implementations. For convenience, this flowchart is described with reference to the system that carries out a method. The system is not necessarily part of the method.

At action 802, a sequence of gesture primitives mapped to gesture segments of a gesture are represented as a gesture-tag sequence that includes one or more characters, such as alphanumeric strings, numbers, currency, data/time, autonumbers, or Boolean.

At action 804, a next component of gesture-tags in the gesture-tag sequence is anticipated based on a model sequence of gesture primitives that identifies future occurrences of one or more subsequent gesture-tags given prior occurrences of one or more previous gesture-tags.

At action 806, the anticipated component is compared with an actual component of gesture-tags representing next gesture primitives.

At action 808, an erroneous fitting of the gesture segments is determined responsive to detecting a mismatch between the next component and actual component.

At action 812, an erroneous interpretation of the gesture is prevented by at least one of not forwarding the mismatched actual component of gesture-tags for interpretation as commands, forwarding the anticipated component of gesture-tags for interpretation as commands instead of the mismatched actual component of gesture-tags, and presenting the mismatched actual component of gesture-tags for human rejection or ratification.

This method and other implementations of the technology disclosed can include one or more of the following features and/or features described in connection with additional methods disclosed. In the interest of conciseness, the combinations of features disclosed in this application are not individually enumerated and are not repeated with each base set of features. Other implementations can include a non-transitory computer readable storage medium storing instructions executable by a processor to perform any of the methods described above. Yet another implementation can include a system including memory and one or more processors operable to execute instructions, stored in the memory, to perform any of the methods described above.

### Frequency Distribution Based Mapping and Error Detection

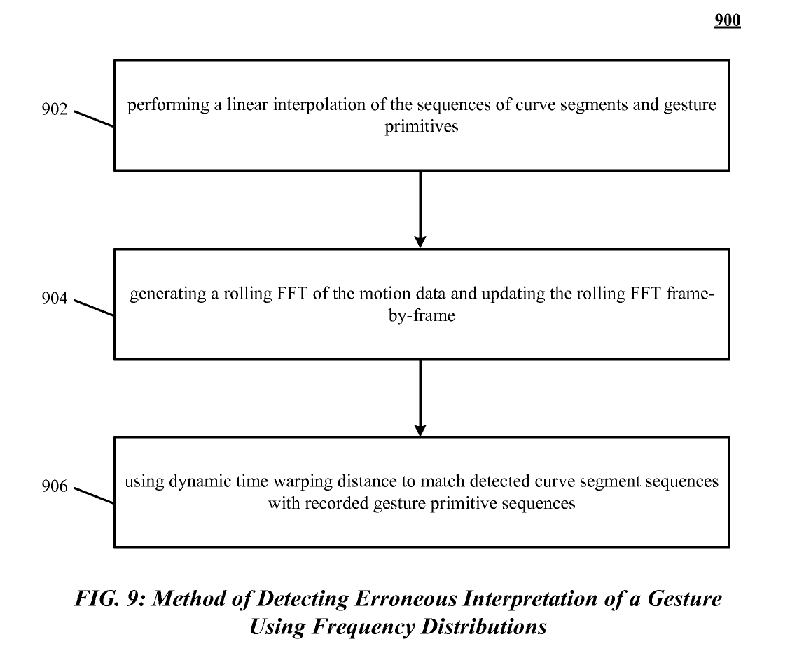

FIG. 9 illustrates a method 900 of detecting erroneous interpretation of a gesture by generating frequency distributions of curve segment and gesture primitive sequences. Flowchart 900 can be implemented at least partially with a database system, e.g., by one or more processors configured to receive or retrieve information, process the information, store results, and transmit the results. Other implementations may perform the actions in different orders and/or with different, fewer or additional actions than those illustrated in FIG. 9. Multiple actions can be combined in some implementations. For convenience, this flowchart is described with reference to the system that carries out a method. The system is not necessarily part of the method.

The sequences of curve segments and gesture primitives can be converted into signals in frequency domain by applying a Fast Fourier Transform (FFT) on vector magnitudes of curve segments and gesture primitives along the time axis. The output of the FFT is a spectrum of frequency distribution of the magnitudes of curve segments and gesture primitives. According to one implementation, a linear interpolation of the sequences of curve segments and gesture primitives is performed at action 902 to amend the length of the sequences so as to convert the sequence lengths to be a power of two, using the following equation, with (x,y) representing interpolated data and (x₀, yθ) and (x₁, y₁) representing data points in the original sequences:

$$y = {y}_{0} + ( x - {x}_{0} ) \frac{{y}_{1} - {y}_{0}}{{x}_{1} - {x}_{0}}$$

In some implementations, a moving average filter is applied to smoothen the frequency distributions of vector magnitudes of curve segments and gesture primitives, according to the following equation:

$${y}_{t} = \frac{{y}_{t - 1} + {y}_{t} + {y}_{t + 2}}{3}$$

In yet some other implementation, the gesture primitives can be parameterized by a FFT of the motion data collected (which can be represented as Cartesian coordinate data i.e., (x,y,z) points, curvilinear coordinates such as curvature and/or torsion, angular coordinates, Frenet-Serret frames, and/or any combination of the above).

Further, a rolling FFT of the data collected can be created and updated frame-by-frame and movement parameters (e.g., motion, path, start and stop points, arc length, translational ranges, curvature, torsion, etc. and/or combinations thereof, and/or parameters computed from combinations thereof) of the curve segments can be matched and mapped to the gesture primitives, at action 904. In another implementation, the FFT parameters can themselves be used as primitive parameters, therefor using the Fourier basis as the primitives. The rolling FFT parameters can be stored in a fixed sized vector, which can then be used to compare against the FFT parameters of the pre-defined gestures seeking recognition.

In one implementation, detected curve segment sequences can be matched with recorded gesture primitive sequences using dynamic time warping distance (DTW), at action 906. In such an implementation, the input is a data time series, D, and a collection of candidate time series, C={c1, c2, c3, . . . , cₙ). The elements in the data time series correspond to the detected curve segments and the elements in the candidate time series represent gesture primitives. Given a set of candidate recorded primitive vectors, a nearest neighbor similarity search across the input time series can be run to search for the closest segment subsequence match to each candidate primitive.

In another implementation, a mismatch between the sequences of curve segments and gesture primitives can also be computed as the L2 (sum-of-squares) norm of the FFT vectors. If the time length of the gesture can be ignored, then a shift normalization or DTW can be used to normalize the primitive vectors, according to some implementations.

This method and other implementations of the technology disclosed can include one or more of the following features and/or features described in connection with additional methods disclosed. In the interest of conciseness, the combinations of features disclosed in this application are not individually enumerated and are not repeated with each base set of features. Other implementations can include a non-transitory computer readable storage medium storing instructions executable by a processor to perform any of the methods described above. Yet another implementation can include a system including memory and one or more processors operable to execute instructions, stored in the memory, to perform any of the methods described above.

Implementations of the technology disclosed can be employed in a variety of application areas, such as for example and without limitation consumer applications including interfaces for computer systems, laptops, tablets, television, game consoles, set top boxes, telephone devices and/or interfaces to other devices; medical applications including controlling devices for performing robotic surgery, medical imaging systems and applications such as CT, ultrasound, x-ray, MRI or the like, laboratory test and diagnostics systems and/or nuclear medicine devices and systems; prosthetics applications including interfaces to devices providing assistance to persons under handicap, disability, recovering from surgery, and/or other infirmity; defense applications including interfaces to aircraft operational controls, navigations systems control, on-board entertainment systems control and/or environmental systems control; automotive applications including interfaces to automobile operational systems control, navigation systems control, on-board entertainment systems control and/or environmental systems control; security applications including, monitoring secure areas for suspicious activity or unauthorized personnel; manufacturing and/or process applications including interfaces to assembly robots, automated test apparatus, work conveyance devices such as conveyors, and/or other factory floor systems and devices, genetic sequencing machines, semiconductor fabrication related machinery, chemical process machinery and/or the like; and/or combinations thereof.

Implementations of the technology disclosed can further be mounted on automobiles or other mobile platforms to provide information to systems therein as to the outside environment (e.g., the positions of other automobiles). Further implementations of the technology disclosed can be used to track the motion of objects in a field of view or used in conjunction with other mobile-tracking systems. Object tracking can be employed, for example, to recognize gestures or to allow the user to interact with a computationally rendered environment; see, e.g., U.S. Patent Application Ser. No. 61/752,725 (filed on Jan. 15, 2013) and Ser. No. 13/742,953 (filed on Jan. 16, 2013), the entire disclosures of which are hereby incorporated by reference.

It should also be noted that implementations of the technology disclosed can be provided as one or more computer-readable programs embodied on or in one or more articles of manufacture. The article of manufacture can be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs can be implemented in any programming language. Some examples of languages that can be used include C, C++, or JAVA. The software programs can be further translated into machine language or virtual machine instructions and stored in a program file in that form. The program file can then be stored on or in one or more of the articles of manufacture.

Certain implementations of the technology disclosed were described above. It is, however, expressly noted that the technology disclosed is not limited to those implementations, but rather the intention is that additions and modifications to what was expressly described herein are also included within the scope of the technology disclosed. For example, it can be appreciated that the techniques, devices and systems described herein with reference to examples employing light waves are equally applicable to methods and systems employing other types of radiant energy waves, such as acoustical energy or the like. Moreover, it is to be understood that the features of the various implementations described herein were not mutually exclusive and can exist in various combinations and permutations, even if such combinations or permutations were not made express herein, without departing from the spirit and scope of the technology disclosed. In fact, variations, modifications, and other implementations of what was described herein will occur to those of ordinary skill in the art without departing from the spirit and the scope of the technology disclosed. As such, the technology disclosed is not to be defined only by the preceding illustrative description.

The terms and expressions employed herein are used as terms and expressions of description and not of limitation, and there is no intention, in the use of such terms and expressions, of excluding any equivalents of the features shown and described or portions thereof. In addition, having described certain implementations of the technology disclosed, it will be apparent to those of ordinary skill in the art that other implementations incorporating the concepts disclosed herein can be used without departing from the spirit and scope of the technology disclosed. Accordingly, the described implementations are to be considered in all respects as only illustrative and not restrictive.

What is claimed is:

1. A method of interpreting complex gestures, the method including:
capturing a plurality of digital images of a non-linear free-form gesture in a three-dimensional (3D) sensory space performed by a control object;
determining a path of movement of the control object during the non-linear free-form gesture;
segmenting the path into multiple curve segments at least one of vertices, mid-points, and inflection points;
piecewise fitting at least some of the curve segments to second or third order curves;
identifying curve primitives in a library that match the piecewise fitted curve segments;
mapping one or more geometric attributes of the piecewise fitted curve segments to parameters of the curve primitives; and
forwarding the mapped parameters and curve primitives to a further process for interpretation as commands.

2. The method of claim 1, wherein the geometric attributes of the curve segments include at least starting and ending points of the curve segments.

3. The method of claim 1, wherein the geometric attributes of the curve segments include at least degrees of curvature of the curve segments.

4. The method of claim 1, wherein the geometric attributes of the curve segments include at least torsion of the curve segments.

5. The method of claim 1, wherein the geometric attributes of the curve segments include at least gradients of the curve segments.

6. The method of claim 1, wherein the geometric attributes of the curve segments include at least orientation of the curve segments.

7. The method of claim 1, wherein the geometric attributes of the curve segments include at least radius of the curve segments.

8. The method of claim 1, wherein mapping geometric attributes of the curve segments to parameters of the curve segments further includes approximating a best-fit curve for the curve segments.

9. The method of claim 1, further including mapping one or more kinematic attributes of the curve segments to parameters of the curve primitives.

10. The method of claim 9, wherein the kinematic attributes of the curve segments include at least one of speed, velocity, and acceleration of the control object during respective curve segments of the free-form gesture.

11. The method of claim 1, further including anticipating a future motion of the control object based on comparing a sequence of curve primitives mapped to the curve segments to a pre-defined ordering of curve primitives that includes the mapped curve primitives.

12. The method of claim 11, further including determining control manipulations responsive to the free-form gesture by:
representing the control manipulations as unique gesture-tag sequences; and
responsive to identifying a subset of the unique gesture-tag sequences in the sequence of curve primitives mapped to the curve segments, performing the control manipulations represented by the subset.

13. The method of claim 1, further including detecting erroneous interpretation of the free-form gesture by:
representing a first sequence of curve primitives mapped to a first set of curve segments as a first gesture-tag sequence;
based on a gesture template that specifies at least one of temporal sequence and combination of gestural-tags representing occurrences of curve segments in a gestural path, identifying a potential gestural-tag sequence that represents a subsequent sequence of curve primitives to be mapped to a future set of curve segments that most likely follow the first set of curve segments; and
detecting an erroneous fitting of the curve segments when a second gesture-tag sequence representing a second set of curve segments following the first set of curve segments differs from the potential gestural-tag sequence above a maximum threshold.

14. A method of detecting erroneous interpretation of a gesture, further including:
representing a sequence of gesture primitives mapped to gesture segments of a gesture as a gesture-tag sequence, wherein the gesture-tag sequence includes one or more characters;
anticipating a next component of gesture-tags in the gesture-tag sequence based on a model sequence of gesture primitives that identifies future occurrences of one or more subsequent gesture-tags given prior occurrences of one or more previous gesture-tags;
comparing the anticipated component with an actual component of gesture-tags representing next gesture primitives; and
determining an erroneous fitting of the gesture segments responsive to detecting a mismatch between the next component and actual component.

15. The method of claim 14, further including preventing erroneous interpretation of the gesture by not forwarding the mismatched actual component of gesture-tags for interpretation as commands.

16. The method of claim 14, further including preventing erroneous interpretation of the gesture by automatically forwarding the anticipated component of gesture-tags for interpretation as commands instead of the mismatched actual component of gesture-tags.

17. The method of claim 14, further including preventing erroneous interpretation of the gesture by presenting the mismatched actual component of gesture-tags for human rejection or ratification.

18. A system of interpreting complex gestures, the system including:
a processor coupled to memory, the memory including computer instructions that, when executed, cause the processor to:
capture a plurality of digital images of a non-linear free-form gesture in a three-dimensional (3D) sensory space performed by a control object;
determine a path of movement of the control object during the non-linear free-form gesture;
segment the path into multiple curve segments at vertices and inflection points;
piecewise fit at least some of the curve segments to second or third order curves;
identify curve primitives in a library that match the piecewise fitted curve segments;
map one or more geometric attributes of the piecewise fitted curve segments to parameters of the curve primitives; and
forward the mapped parameters and curve primitives to a further process for interpretation as commands.

19. The system of claim 18, further configured to determine control manipulations responsive to the free-form gesture by:
representing the control manipulations as unique gesture-tag sequences; and
responsive to identifying a subset of the unique gesture-tag sequences in a sequence of curve primitives mapped to the curve segments, performing the control manipulations represented by the subset.

20. The system of claim 18, further configured to detect erroneous interpretation of the free-form gesture by:
representing a first sequence of curve primitives mapped to a first set of curve segments as a first gesture-tag sequence;
based on a gesture template that specifies at least one of temporal sequence and combination of gestural-tags representing occurrences of curve segments in a gestural path, identifying a potential gestural-tag sequence that represents a subsequent sequence of curve primitives to be mapped to a future set of curve segments that most likely follow the first set of curve segments; and
detecting an erroneous fitting of the curve segments when a second gesture-tag sequence representing a second set of curve segments following the first set of curve segments differs from the potential gestural-tag sequence above a maximum threshold.
